(19) United States
(12) Patent Application Publication
(10) Pub. No.: US 2011/0076633 A1
(43) Pub. Date: Mar. 31, 2011

(54) SELF-LIGATING ORTHODONTIC BRACKET

(75) Inventors: Richard Randle Bryant, Vista, CA (US); Patrick Roman, Escondido, CA (US); Osvaldo Del Castillo, Vista, CA (US); Hector Del Castillo, Vista, CA (US)

(73) Assignee: ORTHODONTIC DESIGN AND PRODUCTION, INC., Vista, CA (US)

(21) Appl. No.: 12/570,340

(22) Filed: Sep. 30, 2009

(51) Int. Cl. A61C 7/32

(52) U.S. Cl. 433/11

(57) ABSTRACT

A self-ligating orthodontic bracket has an archwire slot, two outer tracks extending in an occlusal-gingival direction on the outer lateral surfaces of the bracket, and a vertical trough extending in an occlusal-gingival direction between the outer tracks. A clip has two parallel outer arms and a central tongue between the outer arms. The outer tracks of the bracket slidably engage the outer arms of the clip and the central tongue is slidably engaged by the vertical trough of the bracket, thereby allowing the clip to slidably move between an open position in which the outer arms of the clip are retracted from the archwire slot to allow an archwire to be placed into the archwire slot, and a closed position in which the outer arms of the clip extend across the archwire slot to retain the archwire in the archwire slot.

### BACKGROUND OF THE INVENTION

1. Field of the Invention

The present invention relates generally to the field of orthodontic brackets. More specifically, the present invention discloses a self-ligating orthodontic bracket assembly.

2. Statement of the Problem

Within the field of orthodontics, many treatment philosophies have been introduced over the past century, and many of those have included dedicated hardware systems appropriate for treating orthodontic patients according to a particular philosophy and methodology. Enduring components seen in nearly all orthodontic hardware systems are the bracket and the archwire. Essentially, archwires pass around the dental arches adjacent to the teeth. Energy is stored locally within the resilient archwire by deflecting it in relation to the extent that an adjacent tooth may be malpositioned. Such deflected regions of an archwire are then ligated (i.e., tied) in place to engage the archwire slots of orthodontic brackets, which in turn are rigidly attached to each tooth. The brackets serve as the conveyors of the archwire's stored energy and direct that energy through the roots of the teeth to the supporting bone surrounding the roots. It is the slow dissipation of the energy stored in the deflected archwire that drives the physiological processes of tooth movement.

The present invention involves an improved means for ligating an archwire to each bracket of a system of brackets. To more clearly differentiate the benefits and advantages of the present invention compared to current methodologies, as well as compared to methods and devices used historically, a review of orthodontic ligation methods, materials and procedures follows.

In addition to the bracket's archwire slot referenced above, orthodontic brackets include features known as ligation wings. Ligation wings, sometimes called “tie wings”, are located on opposite sides of the archwire slot and extend gingivally and occlusally away from the slot. Tie wings serve as stanchions for ligature-tying, where a ligature passes under each tie wing while passing over the archwire slot. The tie wings, when viewed from the mesial or distal aspect form the characteristic “mushroom” profile typical of standard orthodontic brackets.

Traditional steel ligatures are formed from fine stainless steel wire. They are fully annealed to a dead-soft temper and are therefore extremely malleable. Ligature wires are still in routine use today and are commercially available in diameters ranging from about 0.009 to about 0.012 inches. To tie-in an archwire, a ligature is looped around one of the bracket's tie wings and then around the other while the archwire is fully in place in the archwire slot. Both ends of a ligature are tightened by pulling, thus tightening the ligature wire over the archwire slot. The ends are then twisted to further cinch the archwire against the floor of the archwire slot. With a ligature in place between the tie wings, an archwire is considered to be “ligated in” and it cannot escape from the slot without first removing the ligature.

Steel ligatures have served for generations of patients, but the amount of time and skill required to change a patient's archwire began to be seen as a bottleneck as orthodontic practices modernized. As orthodontic treatment became more popular and affordable in the 1960's and 1970's, orthodontists began to seek time-saving materials and procedures in order to more efficiently their treat growing numbers of patients. The problem associated with steel wire-based ligation was that each of the (typically) twenty brackets per arch required a steel ligature to be positioned in place around each bracket and then carefully tightened, cut and tucked safely out of the way. In order to reduce the amount of chair time required per patient, new means were developed to reduce the time and the related expense associated with the use of steel ligatures.

A new type of ligature, known as the elastomeric ligature, became commercially available beginning in 1976. Elastomeric ligature are injected molded from elastomeric polymers. Using dedicated instruments for placing elastomeric ligatures, orthodontists and their staff were able to change a patient's archwire more quickly. Elastomeric ligatures are molded in the form of an “o”. Since they are continuous, the time-consuming steps of tying and cutting were no longer required.

As can be appreciated from the foregoing, the specific means for capturing an archwire in a bracket's archwire slot is of central concern for a busy orthodontic practice. Even small improvements in a procedure that may be repeated hundreds of times a day can reap large benefits in terms of staff productivity and in terms of the number of patients that can be seen per day.

The advent of elastomeric ligatures reduced the time required for the doctor or staff to ligate a bracket compared to steel ligature-based procedures, but in spite of that advancement, there remained a need for further time-saving innovations. From the beginning of the orthodontic specialty, a self-ligating bracket had been hypothesized. After all, a self-ligating bracket would require no separate devices other than the bracket itself. So, accordingly, much inventive effort was directed toward developing a practical self-ligating bracket.

In 1930, Dr. Edwin H. Angle introduced a self-ligating bracket, disclosed in U.S. Pat. No. 1,890,487. Dr. James Ford introduced a self-ligating bracket in 1935 via U.S. Pat. No. 2,104,192. Dr. Ford's bracket is still in use today. Dr. Garford Broussard likewise disclosed his self-ligating bracket in 1964 according to U.S. Pat. No. 3,128,552. Many others have made important contributions and improvements since. The first self-ligating bracket to achieve widespread commercial success was developed by a Canadian orthodontist, Dr. Herb Hanson, as disclosed in U.S. Pat. No. 4,492,573. Dr. Hanson's bracket is a two-part assembly consisting of a bracket body structure and a sliding clip. The clip's resilience, in combination with co-working features of the clip and bracket body create a spring-biased open position as well as a spring-biased closed position. An arch wire can be inserted into the slot while the bracket is open and an archwire is retained in the slot with the sliding clip moved to it's closed position. The bracket taught by the '573 patent, along with subsequent improvements, defines one type of self-ligating bracket that has seen world-wide commercial success and remains popular today. It is commercially known as the “Speed System”.

Overall, self-ligating brackets represent about 25% of all brackets used in orthodontic treatment in the U.S. It is believed that generally, self-ligating brackets constitute a somewhat smaller percentage of brackets used brackets in the rest of the world. Most self-ligating brackets fall into three general categories, as discussed below.

For the reader's reference, a first category of self-ligating brackets includes a hinged cap that opens to permit insertion of an archwire, then closes to capture the archwire. A positive latching means retains the hinged cap in a closed position. Examples of this first category are shown in U.S. Patent Application Pub. 2006/0252002 (Hanson), U.S. Pat. No. 6,726,474 (Spencer), U.S. Patent Application Pub. 2008/0241782 (Abeis et al.), U.S. Pat. No. 6,607,383 (Abels et al.), U.S. Pat. No. 7,025,591 (Kesling) and U.S. Pat. No. 4,712,999 (Rosenberg).

A second category of self-ligating brackets cinches the archwire. In other words, the archwire itself is forced between or against resilient members, which then expand, deflect or spring apart to permit entry of the archwire into the archwire slot. Once the archwire is fully seated in the slot, the same spring properties reduce the dimensions of the opening, thereby mechanically capturing the archwire in the slot. Examples of this second category are shown in U.S. Pat. No. 7,377,777 (Lai et al.), U.S. Pat. No. 7,140,876 (Cinader et al.), U.S. Pat. No. 7,252,505 (Lai), U.S. Pat. No. 7,175,428 (Nicholson), U.S. Pat. No. 7,014,460 (Lai et al.), U.S. Pat. No. 6,984,127 (Lai) and U.S. Pat. No. 6,582,226 (Jordan et al.).

The third category of self-ligating bracket employs a slider mechanism (e.g., a flat cap or plate that slides lineally within grooves or guides). At one end of the slider mechanism's range, the archwire slot is closed and at the other, it is open. Any of a variety of structures can be used to bias or retain the slider mechanism in its open position or its closed position. Examples of this third category are disclosed in U.S. Pat. No. 7,419,375 (Farzin-Nia et al.), U.S. Pat. No. 6,071,118 (Damon), U.S. Pat. No. 7,267,545 (Oda), U.S. Pat. No. 5,466,151 (Damon) and U.S. Pat. No. 7,416,408 (Farzin-Nia et al.). The foregoing examples depicting basic design-types seen in the self-ligating bracket art represent known and commercially-popular designs, but the listing should not be considered complete or exhaustive. Other approaches to self-ligating bracket designs have been introduced and proven successful.

The present invention relates most closely to the third category of self-ligating brackets described above. Again, this third category is exemplified by a flat cap sliding linearly in an occlusal-gingival axis within inward-facing grooves or guides formed in the inner faces of the traditional pair of tie wings. For those brackets, one extreme of the cap's sliding range positions the cap in its closed position, and at the other, it is in the open position. Other structures typically serve to bias or retain the sliding cap in its open position or its closed position. FIG. 1 of the U.S. Pat. No. 7,416,408 to Farzin-Nia can be considered as a representative example of known designs in this category.

Even though currently popular, brackets of this third category present several problems or limitations in use. Those limitations are addressed by the improvements incorporated in the present invention. One inherent limitation of this third category of brackets arises from the fact that the bracket is composed of two pairs of tie wings, each with a gingival and an occlusal stanchion portion for engaging a conventional wire ligature or elastomeric ligature. Even for self-ligating brackets in the third category that lack features for accommodating a conventional ligature, a monolithic mesial and monolithic distal structure on the mesial and distal sides of the bracket respectively will be present to support the sliding cap feature. Such tie wings or monolithic structures are typically 0.030 to 0.040 in. wide in the mesial-distal axis. The depth of the groove structurally removes about half of that material thickness. Therefore, it is only the remaining material adjacent to the groove that must be capable of resisting the wrenching and potentially destructive forces generated by a highly-deflected archwire as it is restrained within the archwire slot. It is not unusual for high archwire forces to be generated locally between mal-positioned teeth, particularly early in treatment.

To restate this structural matter in different terms, it can be said that there is a requirement that ample thickness of the bracket body material remain adjacent to the groove. This remaining material adjacent to the groove must be sufficiently strong to resist bending, distortion and failure of the bracket body that may be created by the archwire during treatment and the forces it wrests against the sliding cap. This requirement places limits to the depth to which the grooves can be formed into the inner faces of the tie-wings/monolithic structures. These factors, combined, then contribute to place a limit on the maximum allowable mesial-distal width of such a sliding cap. Due to structural loading considerations, the sliding cap must be undesirably narrowed, compared to the full mesial-distal width of the bracket body.

What problem does the narrowing of the sliding cap present? Considering that the bracket and archwire are required to work together to deliver physiologically effective forces to the boney support around the root of a tooth, a narrowed cap reduces the mechanical moment that the bracket/archwire system is capable of generating. Particularly for correction in terms of rotation, a narrowed cap undesirably reduces the maximum rotational moment that the bracket/archwire can transfer to the root of a tooth.

In addition to reduced treatment forces, another shortcoming associated with self-ligating brackets of the third category is compromised hygiene. The grooves in which a cap slides typically face inward toward each other. Being inward-facing, the spaces within the grooves are somewhat sheltered from the natural rinsing or flushing effect of saliva from the normal motions of lips, cheeks and tongue. Such sheltered or confined areas of orthodontic hardware tend to become harbors for bacteria where tarter and calculus deposits can accumulate. When such deposits accumulate while in contact with stainless steel, for example, the oxygen taken up by bacteria can reduce or even deplete the elemental oxygen bound-up in the chromium-oxide skin of stainless steel. It is only this exceedingly thin chromium-oxide film that imparts the desirable, corrosion-resistant properties to stainless steel. Once depleted, the protective skin leaves the underlying metal susceptible to a type of corrosion known as “crevice corrosion”.

Orthodontic treatment is based predominantly on the use of stainless steel hardware. At points where the passive stainless properties have been compromised, oral bacteria in contact with elemental iron of the stainless steel create a “smut”. The smut is a mix of metallurgical and organic debris and presents as a foul, dark-colored oily paste. It is an unhealthy development that compromises overall oral hygiene and when it occurs, it is a strong irritant to the adjacent soft tissues. Some researchers have claimed that smut in contact with tooth enamel can permanently stain enamel and cause decalcification of the enamel.

Even in the mouths of hygiene-conscious orthodontic patients, bacteria harbors are formed in various hidden crevices of stainless steel orthodontic hardware. The compromised inward-facing grooves of self-ligating brackets in the third category described above can become even more of a conducive environment for bacteria once the sliding cap is considered. Suffice it to say, self-ligating bracket designs that include sheltered features or hidden crevices are to be avoided.

For the purposes of this disclosure, a frame of reference will be used that is commonly employed in dentistry. The term “gingival” refers to a direction toward a patient's gingiva or gum. The term “occlusal” is the opposite of “gingival” and refers to a direction toward the occlusal surface of a tooth (i.e., toward the bite plane between the upper and lower teeth). The term “mesial” (or the adjective “mesio”) refers to a direction toward the mid-line of a patient's dental arch. The term “distal” is the opposite of “mesial” and refers to a direction away from the mid-line of a patient's dental arch. The term “lateral” refers to either the mesial or distal aspects of a tooth. The term “lingual” refers to a direction toward the patient's tongue. The term “labial” is opposite of “lingual” and refers to a direction away from the tongue and toward the lips or cheek.

### SOLUTION TO THE PROBLEM

The present design introduces features and improvements that avoid these problems associated with self-ligating brackets with slider mechanisms. In particular, the present invention provides a self-ligating bracket with a configuration that reduces the tendency for bacteria harbors to form by incorporating outward-facing grooves. Unlike the grooves described earlier, outward-facing grooves are better exposed to benefit from increased exposure to the rinsing and flushing effects of saliva. Brushing and the motions of the lips, cheeks and tongue all serve to evacuate debris from outward-facing grooves.

In addition, the clip employed in the present invention presents improvements directly related to the physiological forces generated by the archwire/bracket system. It is important to consider the free span of an archwire as it extends from one bracket/tooth to the next. The term “free span” here refers to the section of the archwire that is out of physical contact with the brackets on both ends of that span. As can be appreciated, archwires are to a degree captured in the archwire slots of the brackets. Particularly in the case where a full-sized, rectangular archwire is employed, three sides of such an archwire will be in intimate contact with the walls and floors of the archwire slots of the brackets. This condition will load the archwire in bending and in torsion as the archwire attempts to accommodate the mal-aligned slots by twisting and bending in the free span in response.

What is the significance of the free span or inter-bracket distance? It can be said that as inter-bracket distance increases, the unit strain imparted into the archwire decreases. The physiological force levels impinging on the roots also decreases and within a range, the rate of tooth movement may slow. In contrast, as inter-bracket distance decreases, the strain imparted into the archwire must be accommodated within a shorter span. Therefore, stress on the archwire increases and the physiological force levels impinging on the roots of the teeth increases. Within a physiological range, tooth movement may proceed somewhat more rapidly.

The ideal orthodontic response to treatment forces requires that gentle, continuous forces be applied to the alveolar bone surrounding the roots of the teeth. If those forces are excessive, tooth movement can slow or even stop. If those forces are insufficient, tooth movement can similarly slow or stop. Within the ideal range of forces however, teeth can be urged to move desirably faster with slightly higher forces.

The present invention serves to decrease inter-bracket distance by employing a clip with outer arms that slide along tracks or grooves on the outer lateral surfaces of the bracket. This enables the effective mesial-distal width of the sliding clip to extend to the full mesial-distal width of the bracket. The mesial-distal width of the clip, as it slides in these outward-facing tracks is not limited as to its width. In fact, the clip can be formed to be wider than the full mesial-distal width of the bracket body if so desired. Maximizing the width of the clip leads to a more optimized configuration for enhancing rotational forces exerted on the archwire and the patient's teeth.

### SUMMARY OF THE INVENTION

This invention provides a self-ligating orthodontic bracket having an archwire slot, two outer tracks extending in an occlusal-gingival direction on the outer lateral surfaces of the bracket, and a vertical trough extending in an occlusal-gingival direction between the outer tracks. A clip has two parallel outer arms and a central tongue between the outer arms. The outer tracks of the bracket slidably engage the outer arms of the clip and the central tongue is slidably engaged by the vertical trough of the bracket, thereby allowing the clip to slidably move between an open position in which the outer arms of the clip are retracted from the archwire slot to allow an archwire to be placed into the archwire slot, and a closed position in which the outer arms of the clip extend across the archwire slot to retain the archwire in the archwire slot.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is an exploded perspective view of the bracket 30 with the clip 20 removed.

FIG. 1a is a cross-sectional view of the bracket 30 taken along the plane of the tracks used to engage the clip 20.

FIG. 2 is a perspective view of the bracket assembly with the clip 20 in its closed position.

FIG. 3 is a front elevational view corresponding to FIG. 2 showing the bracket assembly with the clip 20 in its closed position and an archwire 15 positioned in the archwire slot 34.

FIG. 4 is a front elevational view of the bracket assembly bonded to a tooth 10, and the clip 20 in an open position.

FIG. 5 is a perspective view of another embodiment of the bracket assembly with a clip 20 having a gingival spine 22.

FIG. 6 is a front elevational view corresponding to FIG. 5 showing the bracket assembly with the clip 20 in its closed position.

FIG. 7 is a cross-sectional view of the bracket assembly in FIGS. 5 and 6 taken along the plane of the clip 20.

FIG. 8 is a front elevational view corresponding to FIG. 5 showing the bracket assembly with the clip 20 in its open position.

FIG. 9 is a cross-sectional view of the bracket assembly in FIG. 8 taken along the plane of the clip 20.

FIG. 10 is a front elevational view of another embodiment of the bracket assembly having a different arrangement of stop members, with the clip 20 in a closed position.

FIG. 11 is a cross-sectional view of the bracket assembly in FIG. 10 taken along the plane of the clip 20, but with the clip 20 in its open position.

FIG. 12 is a front elevational view of another embodiment of the bracket assembly having ears 23 extending laterally from the clip 20. The clip 20 is shown in its closed position.

FIG. 13 is a cross-sectional view of the bracket assembly in FIG. 12 taken along the plane of the clip 20, but with the clip 20 in its open position.

### DETAILED DESCRIPTION OF THE INVENTION

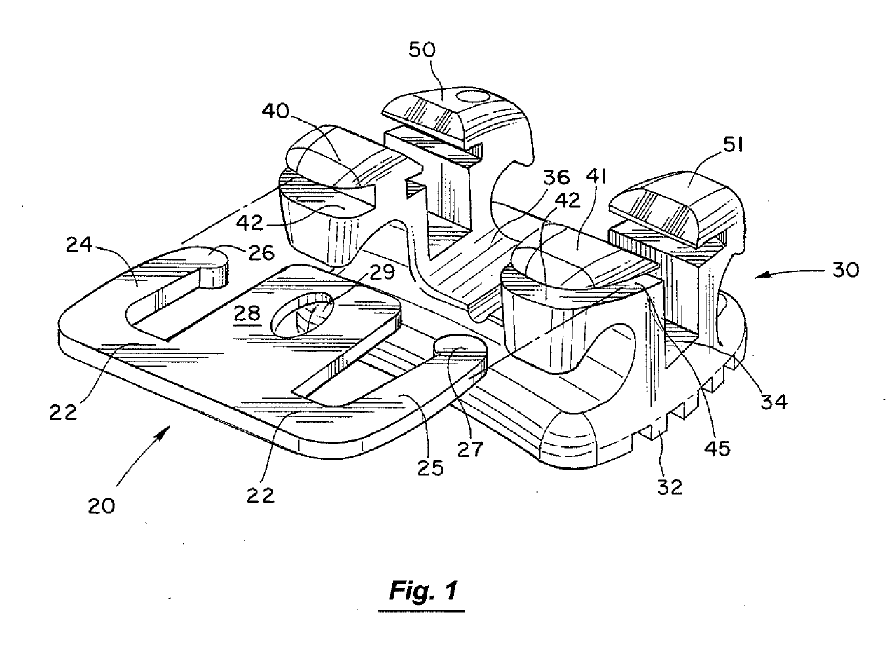

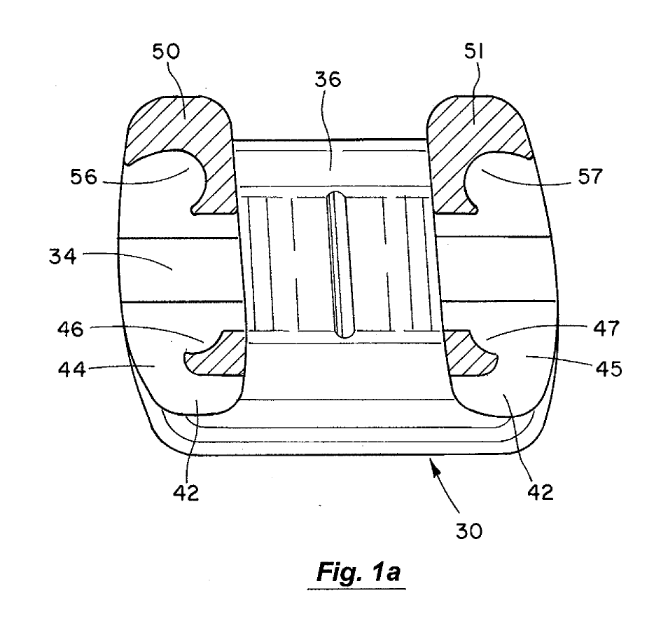

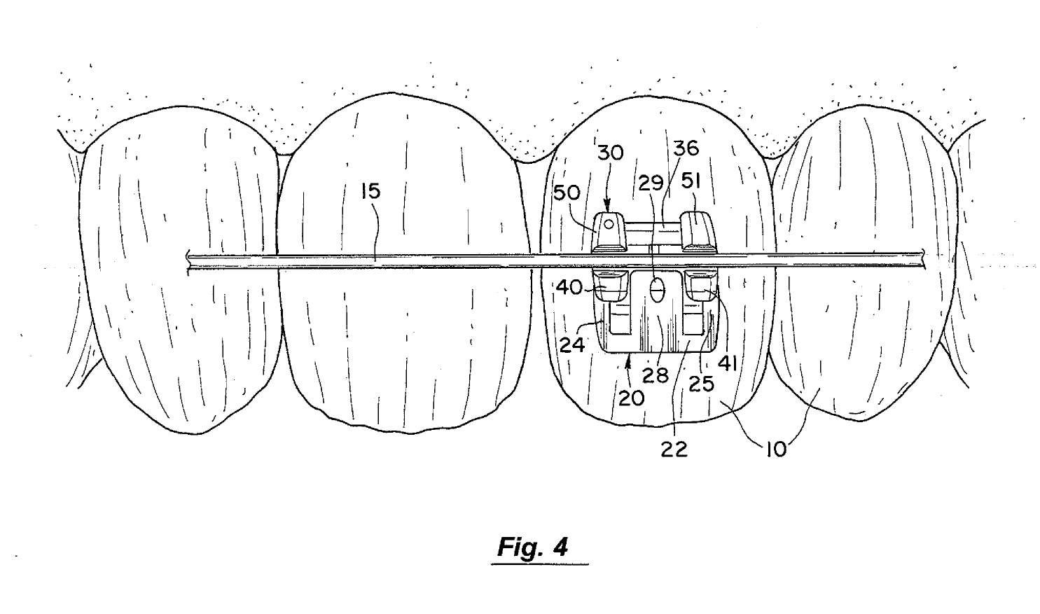

Turning to FIG. 1, an exploded perspective view is depicted of an embodiment of the present invention. The major components are a bracket 30 with the sliding clip 20. The bracket 30 has a conventional base 32 for attachment to a tooth 10 (e.g., by adhesive), as illustrated in FIG. 4. An archwire slot 34 extends in a substantially horizontal, or mesio-distal direction across the body of the bracket 30 with an open labial aspect to receive an archwire 15. The archwire slot 34 can have a cross-section forming three sides of a rectangle, as shown in FIG. 1, to better engage an archwire having a rectangular cross-section.

Two outer tracks 44 and 45 extend in a substantially occlusal-gingival direction on the outer lateral surfaces of the bracket 30. In other words, one outer track 44 runs along the mesial surface, and the other outer track 45 runs along the distal surface of the bracket 30. Both outer tracks 44, 45 start from the occlusal aspect of the bracket 30 and extend substantially parallel to one another across the archwire slot 34 at a distance labial to the floor of the archwire so that an archwire can be secured in the archwire slot 34 by the clip 20 as it slides in these outer tracks 44, 45. The dimension from the floor of the archwire slot 34 to the floor of the outer tracks 44, 45 corresponds to the cross-sectional dimension of an archwire 15.

A central vertical trough 36 extends in a substantially vertical, or occlusal-gingival direction between the outer tracks 44, 45 from the occlusal aspect of the bracket. The bracket 30 may also include an occlusal slot 42 that extends along the occlusal surfaces of the bracket 30 between the occlusal ends of the outer tracks 44 and 45. The occlusal slot 42 serves to hold the clip 20 down as a patient bites into food. Also, the occlusal slot 42 helps to prevent soft tissue of the lips from rubbing against the rather sharp occlusal corners of clip 20.

As shown in FIG. 1, the body of the bracket can be largely formed by two occlusal tie wings 40, 41 and two gingival tie wings 50, 51 that extend labially from the base of the bracket. In this embodiment, these four tie wings 40, 41, 50 and 51 are arranged in a grid pattern with space between adjacent tie wings. Thus, the archwire slot 34 is defined by the mesio-distal channel between the occlusal tie wings 40, 41 and the gingival tie wings 50, 51. The central vertical trough 36 is defined by the occlusal-gingival channel between tie wings 40, 50 and 41, 51.

The other major component of the present invention is the clip 20 that is held in sliding engagement with the bracket 30. The clip 20 can slide between an open position in which the clip 20 is retracted from the archwire slot 34 of the bracket 30, and a closed position in which the clip extends across the archwire slot 34 to secure an archwire in the archwire slot 34. In the embodiment depicted in FIGS. 1-4, the clip 20 has an spine 22 extending in mesio-distal direction along the occlusal edge of the clip 20. Two outer arms 24, 25 extend parallel to one another from the ends of the spine 22. The outer arms 24, 25 are designed to slide along the outer tracks 44, 45 of the bracket 30 between the open and closed positions. At least a portion of the spine 22 of the clip 20 seats in the occlusal slot 42 of the bracket 30 in the closed position.

The clip 20 also includes a central tongue 28 extending from the spine 22 between the outer arms 24, 25. The central tongue 28 slides in the vertical trough 36 as the clip 20 is moved between its open and closed positions. The central tongue 28 serves as a guide to maintain proper alignment of the clip 20 with respect to the bracket 30 during assembly and movement of the clip 20. The central tongue 28 helps to prevent the clip 20 from becoming cocked out of proper alignment with the tracks 44, 45 of the bracket, which could otherwise result in damage to the outer arms 24, 25 or spine 22 of the clip 20. The central tongue 28 is relatively wide and provides a large degree of structural rigidity for the clip 20 in general, and the spine 22 in particular. Additionally, the central tongue 28 has sufficient length in the embodiment shown in FIGS. 1-4 to extend across the archwire slot 34 in the closed position, and thereby provides an additional structural member to secure an archwire in the archwire slot 34. The central tongue 28 can be equipped with a hole 29, detent or protrusion. This feature serves as a guide for accepting the tip of a dental scalar or explorer. The tip of the instrument can be placed against the bracket body. With a prying movement, the instrument will pry the sliding clip 20 open or closed.

Preferably, the entire clip 20 is substantially planar. The clip 20 can be formed as one piece from a resilient biocompatible material, preferably a metal such as stainless steel, cobalt chromium, a titanium alloy or a nickel-titanium alloy. Secondary heat treatment may be needed for some metals or alloys to impart sufficient spring properties.

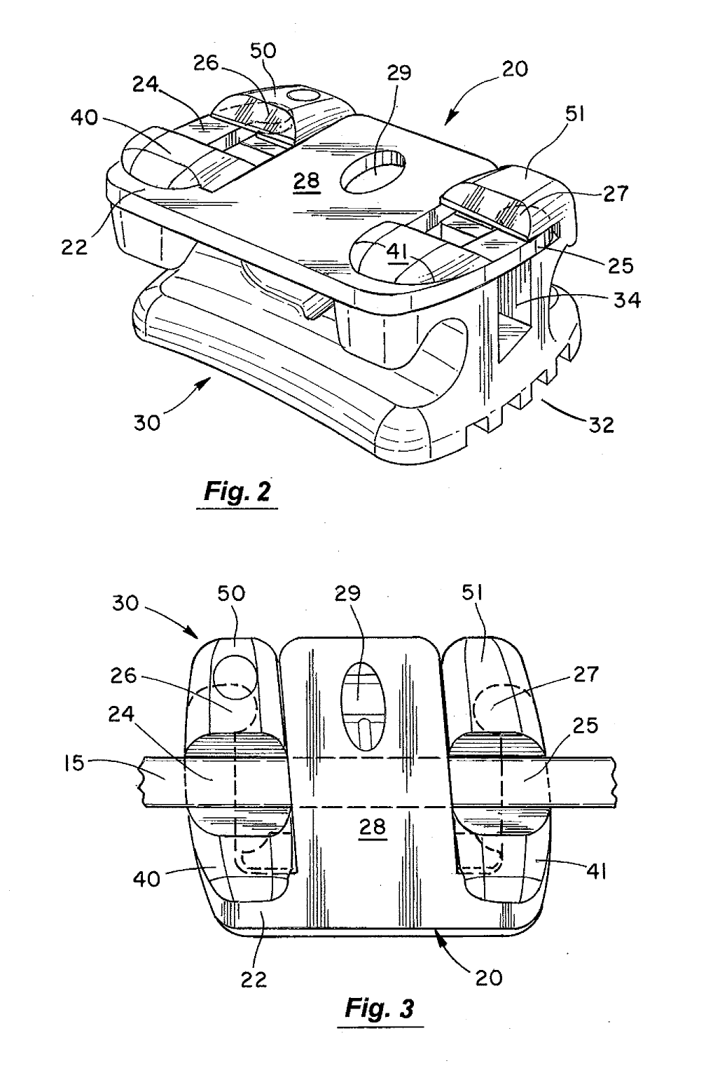

In the embodiment illustrated in FIGS. 1-4, the clip 20 is inserted into the tracks 44, 45 and vertical trough 36 from the occlusal aspect of the bracket 30 during initial assembly. After assembly, the clip 20 slides in the tracks 44, 45 and vertical trough 36 in a generally occlusal-gingival direction between a closed position and an open position. In the closed position, the outer arms 24, extend across the archwire slot 34 to retain an archwire 15 in the archwire slot 34, as shown in FIG. 3. Optionally, the central tongue 28 can also extend across the archwire slot in the closed position, as shown in FIGS. 2 and 3. In the open position shown in FIG. 4, the outer arms 24, 25 and the central tongue 28 of the clip 20 are retracted from the archwire slot 34 to allow an archwire 15 to be inserted or removed from the archwire slot 34.

The open and closed positions are defined for a series of stops incorporated into the structures of the clip 20 and/or bracket 30 to limit the range of motion of the clip 20 with respect to the bracket 30 after initial assembly. In particular, it would be undesirable for the clip 20 to be able to accidentally slide off the bracket 30, and risk the patient swallowing it or suffering laceration of soft tissue. It would also be undesirable for the clip 20 to accidentally move from a closed position to an open position and thereby risk releasing the archwire.

To address these concerns, the embodiment of the clip 20 shown in FIGS. 1, 2, 3 and 4 includes two inward-extending rounded protrusions 26, 27 near the ends of the outer arms 24, 25 of the clip 20. The protrusions 26, 27 engage a corresponding first set of recesses 46, 47 (e.g., rounded detents) in the outer lateral tracks 44, 45 on the occlusal side of the archwire slot 34 in the open position. In the closed position, the protrusions 26, 27 engage a second set of recesses 56, 57 on the gingival side of the archwire slot 34. The outer arms 24, 25 of the clip 20 essentially act as springs as the protrusions 26, 27 engage the recesses 46, 47 or 56, 57. In order to begin moving from either the closed or open position requires the contacting surfaces of the protrusions 26, 27 and recesses to cam against one another and spring the outer arms 24, 25 of the clip outward and apart from one another. The same spring forces tend to hold the clip 20 in place once it reaches its destination. The protrusions 26, 27 energetically fall into the recesses 46, 47 or 56, 57 associated with the new position of the lip 20. While in transit between positions, the protrusions 26, 27 can slide along the walls of the tracks 44, 45.

Shapes based on elliptical and oval curves could also be used for the protrusions alone, or both the protrusions and the recesses. It should be understood that the protrusions could extend lingually or labially to engage complementary recesses in the tracks, or the protrusions could be placed elsewhere in the clip arms. The locations of the protrusions and recesses can be reversed, so that the clip has recesses and the tracks have protrusions. Other suitable complementary combinations of protrusions and recesses, tabs and slots, track constrictions or edges could also be employed on either the clip 20 or the bracket 30. The central tongue 28 can also be equipped with protrusions/recesses that engage complementary recesses/protrusions in the vertical trough 36. However, these features should clear an archwire if in position.

Stated in more general terms, the clip 20 can be said to have a set of clip stop members 26, 27 that energetically engage corresponding first and second track stop members in the open and closed positions, respectively. Returning to the embodiment shown in FIGS. 1-4, the protrusions 26, 27 constitute the clip stop members. FIG. 1a is a cross-sectional view of the bracket 30 taken along the plane of the tracks 26, 27 used to engage the clip 20. Recesses 46, 47 constitute the first track stop members that energetically engage the clip stop members in the open position. Recesses 56, 57 constitute the second track stop members that energetically engage the clip stop members in the closed position.

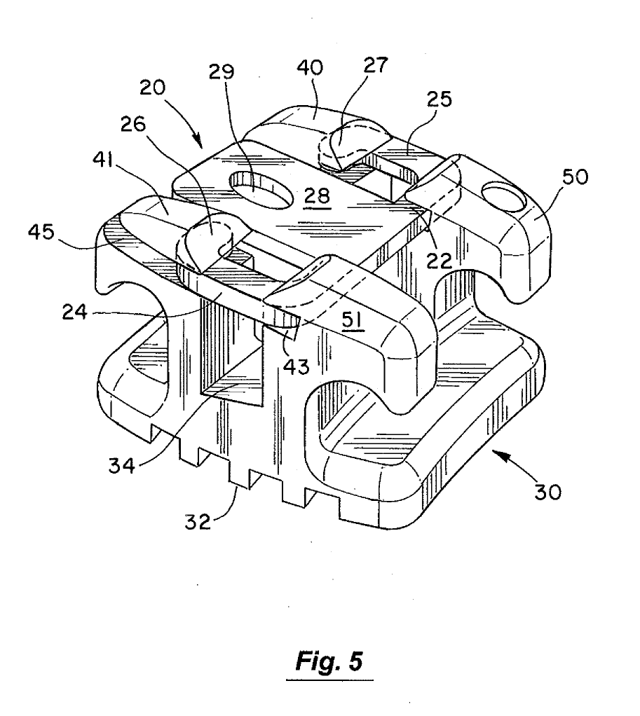

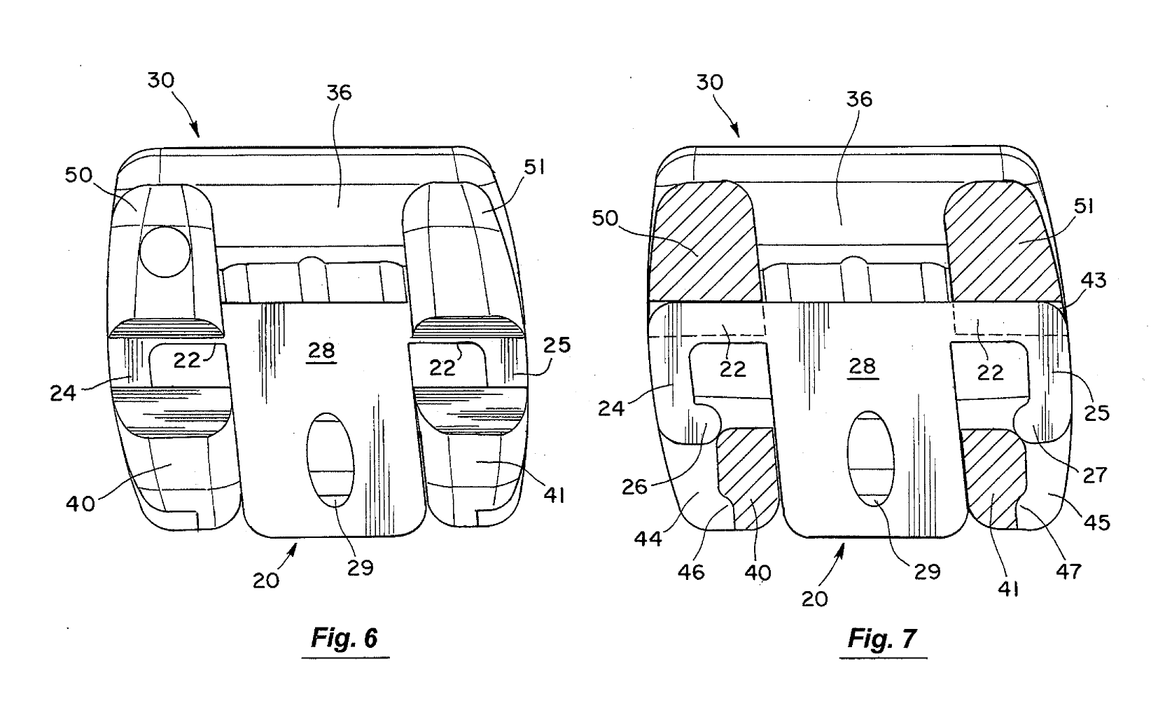

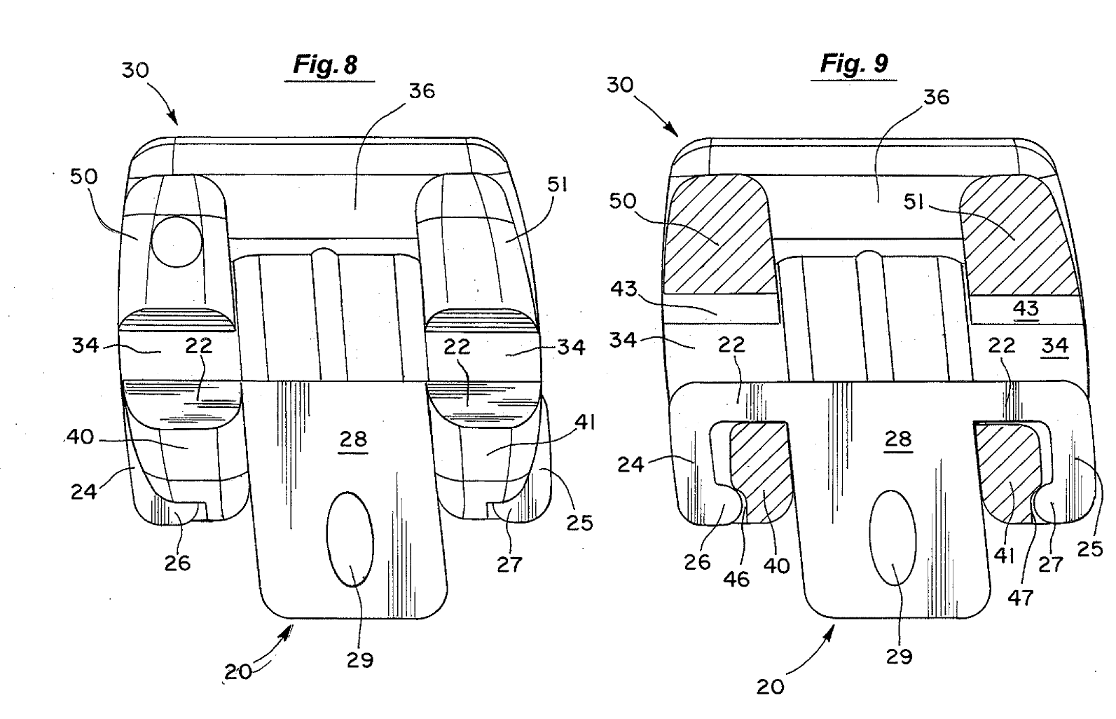

FIGS. 5-9 illustrate a second embodiment of the present invention in which the orientation of the clip 20 is reversed and the outer arms 24, 25 have been shortened. Here, the spine 22 is located on the gingival aspect of the clip 20. FIG. 5 is a perspective view of this embodiment. FIG. 6 is a front elevational view corresponding to FIG. 5 showing the bracket assembly with the clip 20 in its closed position. FIG. 7 is a cross-sectional view of the bracket assembly taken along the plane of the clip 20. FIG. 8 is a front elevational view showing the bracket assembly with the clip 20 in its open position. FIG. 9 is a cross-sectional view of the bracket assembly in FIG. 8 taken along the plane of the clip 20. Note that the spine 22 of the clip 20 seats in a shallow slot 43 in the occlusal face of the gingival tie wings 50, 51 adjacent to the archwire slot 34 in the closed position. This slot 43 provides additional structural support for the clip 20 in the closed position.

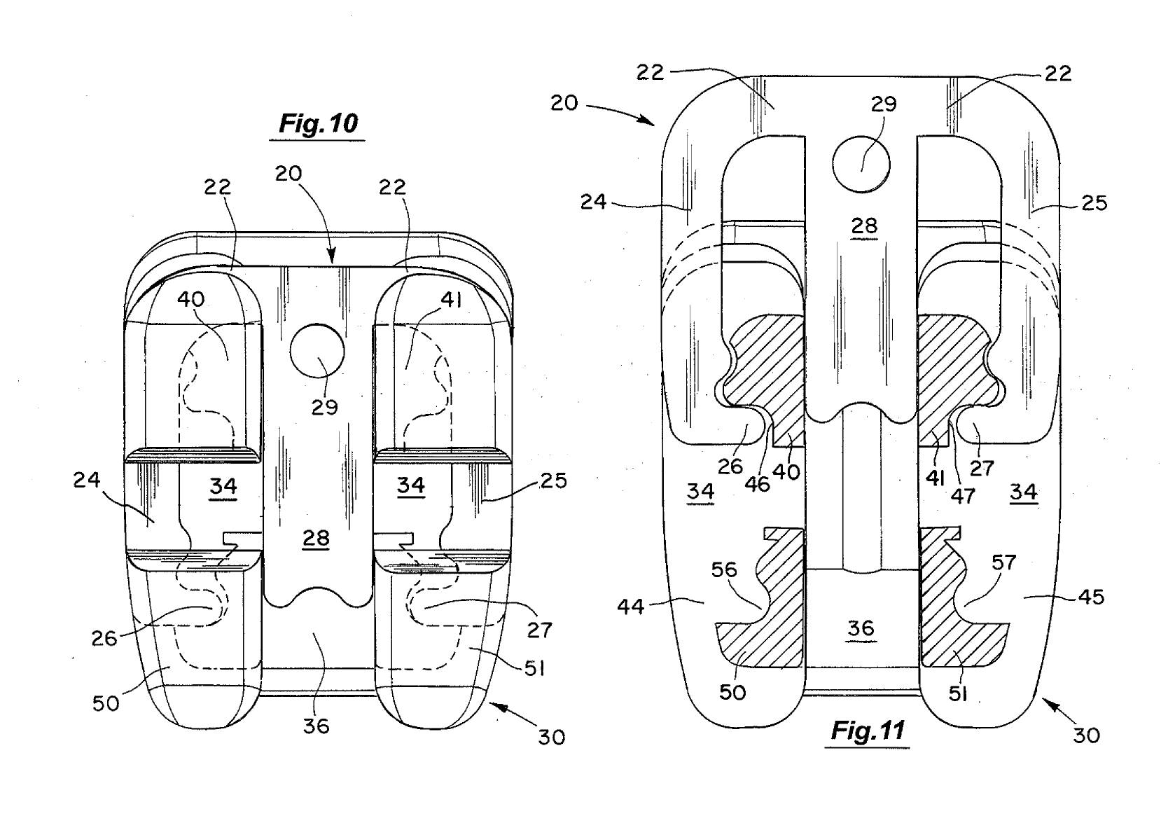

FIGS. 10 and 11 show another embodiment of the bracket assembly having multiple stop members on each arm 24, 25 of the clip 20. FIG. 10 is a front elevational view with the clip 20 in a closed position. FIG. 11 is a cross-sectional view of the bracket assembly taken along the plane of the clip 20, but with the clip 20 in an open position. Also, the outer arms 24, 25 and central tongue 28 have been lengthened, and the central tongue 28 is narrower. These proportions help to prevent the clip 20 from cocking or jamming in the bracket 30. It should be understood that different dimensions and proportions may be designed for different teeth in a patient's dental anatomy.

The outer arms 24, 25 and central tongue 28 in this embodiment are orthogonal to the spine 22 of the clip 20, unlike the previous embodiments. Although the outer arms 24, 25 and central tongue 28 are usually parallel to one another to allow the clip 20 to slide freely on the bracket 30, these components are not necessarily orthogonal to the spine and are not necessarily in a strictly occlusal-gingival orientation, depending on the natural rhomboid shape of the crowns of some of the teeth. For example, the bracket 30 and clip 20 are shown as essentially orthogonal in FIG. 10, but the entire assembly may be based on a rhomboid shape as illustrated in FIG. 8. The same considerations also apply for the orientations of the outer lateral tracks 44, 45 and vertical trough 36 of the bracket 30. When rhomboid, the angulation of the features is carried throughout the assembly.

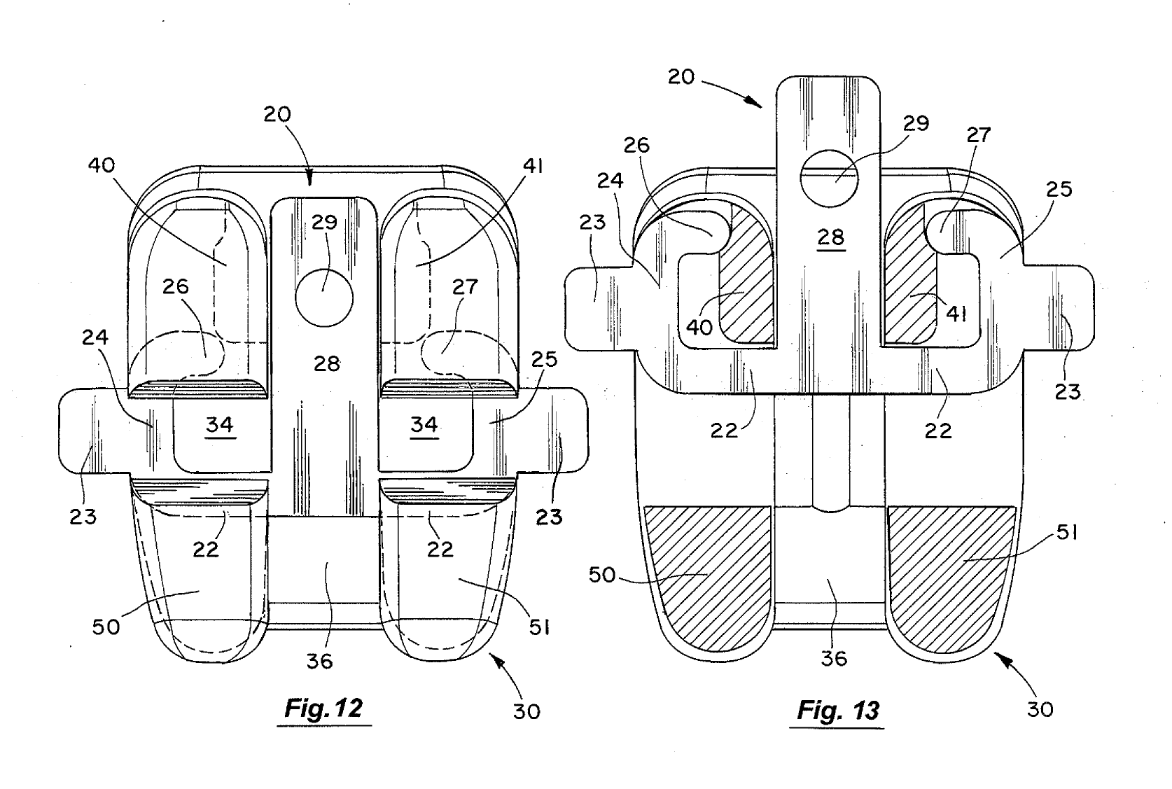

FIGS. 12 and 13 show an embodiment of the bracket assembly having ears 23 extending laterally outward from the clip 20. FIG. 12 is a front elevational view with the clip 20 in its closed position. FIG. 13 is a cross-sectional view taken along the plane of the clip 20, but with the clip 20 in its open position. The ears 23 can be grasped with pliers or engaged with a dental implement to slide the clip 20. The ears 23 also increase the effective width of the clip to thereby decrease the effective inter-bracket distance.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

1. A self-ligating orthodontic bracket assembly comprising:
a clip having parallel outer arms and a central tongue between and parallel to the outer arms; and
a bracket having outer lateral surfaces and an occlusal surface with:
(a) an archwire slot extending mesio-distally through the bracket for receiving an archwire;
(b) outer tracks extending in a substantially occlusal-gingival direction on the outer lateral surfaces of the bracket for slidably engaging the arms of the clip; and
(c) a vertical trough extending in a substantially occlusal-gingival direction between the outer tracks for slidably engaging the central tongue of the clip; said clip being slidably movable between an open position in which the outer arms of the clip are retracted from the archwire slot to allow an archwire to be placed into the archwire slot, and a closed position in which the outer arms of the clip extend across the archwire slot.

2. The self-ligating orthodontic bracket assembly of claim 1 wherein the bracket further comprises gingival and occlusal tie wings, and wherein the outer tracks extend on the outer lateral surfaces of the tie wings.

3. The self-ligating orthodontic bracket assembly of claim 1 wherein the clip further comprises a transverse member from which the outer arms and central tongue extend, and wherein the bracket further comprises a track on the occlusal aspect of the bracket for receiving at least a portion of the occlusal transverse member of the clip in the closed position.

4. The self-ligating orthodontic bracket assembly of claim 1 wherein the clip further comprises a gingival transverse member extending in a mesio-distal direction from which the outer arms and central tongue extend.

5. The self-ligating orthodontic bracket assembly of claim 1 wherein the clip further comprises a hole for receiving a tool to move the clip between the open and closed positions.

6. The self-ligating orthodontic bracket assembly of claim 1 wherein the outer arms of the clip further comprise a clip stop member, and wherein the outer tracks of the bracket further comprise first and second track stop members for engaging the clip stop member at the open and closed positions of the clip.

7. The self-ligating orthodontic bracket assembly of claim 6 wherein the clip stop member comprises a protrusion on the end of an outer arm, and wherein the track stop members comprise complementary recesses spaced along the outer tracks to engage the protrusion in the open and closed positions.

8. A self-ligating orthodontic bracket assembly comprising:
a clip having:
(a) an occlusal transverse member;
(b) parallel outer arms extending from the occlusal transverse member;
(c) a central tongue extending from the occlusal transverse member between and parallel to the outer arms; and
(d) a clip stop member; and
a bracket having:
(a) gingival tie wings;
(b) occlusal tie wings having outer lateral surfaces and occlusal surfaces; said tie wings defining:
(i) an archwire slot extending mesio-distally between the gingival and occlusal tie wings for receiving an archwire; and
(ii) a vertical trough extending in a substantially occlusal-gingival direction between the occlusal tie wings for slidably engaging the central tongue of the clip;
(c) outer lateral tracks extending in an occlusal-gingival direction on the outer lateral surfaces of the occlusal tie wings for slidably engaging the outer arms of the clip;
(d) a first track stop member on an occlusal tie wing for engaging the clip stop member to define an open position for the clip in which the outer arms of the clip are retracted from the archwire slot to allow an archwire to be placed into the archwire slot;
(e) a second track stop member on a tie wing for engaging the clip stop member to define a closed position for the clip in which the outer arms of the clip extend across the archwire slot to retain an archwire in the archwire slot; and
(f) an occlusal slot extending mesio-distally on the occlusal surfaces of the occlusal tie wings for receiving at least a portion of the occlusal transverse member of the clip in the closed position.

9. The self-ligating orthodontic bracket assembly of claim 8 wherein the clip stop member comprises an inward-extending protrusion on an outer arm of the clip, and wherein the first and second track stop members comprise complementary recesses spaced along an outer lateral track of a tie wing.

10. The self-ligating orthodontic bracket assembly of claim 8 wherein the clip further comprises a hole for receiving a tool to move the clip between the open and closed positions.

11. A self-ligating orthodontic bracket assembly comprising:
a clip having:
(a) a gingival transverse member;
(b) parallel outer arms extending from the gingival transverse member;
(c) a central tongue extending from the gingival transverse member between and parallel to the outer arms; and
(d) a clip stop member; and
a bracket having:
(a) gingival tie wings;
(b) occlusal tie wings having outer lateral surfaces; said tie wings defining:
(i) an archwire slot extending mesio-distally between the gingival and occlusal tie wings for receiving an archwire; and
(ii) a vertical trough extending in a substantially occlusal-gingival direction between the occlusal tie wings for slidably engaging the central tongue of the clip;
(c) outer lateral tracks extending in an occlusal-gingival direction on the outer lateral surfaces of the occlusal tie wings for slidably engaging the outer arms of the clip; and
(d) a first track stop member on an occlusal tie wing for engaging the clip stop member to define an open position for the clip in which the outer arms and gingival transverse member of the clip are retracted from the archwire slot to allow an archwire to be placed into the archwire slot; and
(e) a second track stop member on an occlusal tie wing for engaging the clip stop member to define a closed position for the clip in which the outer arms and gingival transverse member extend across the archwire slot.

12. The self-ligating orthodontic bracket assembly of claim 11 wherein the clip stop member comprises a protrusion on the distal end of an outer arm of the clip.

13. The self-ligating orthodontic bracket assembly of claim 11 wherein the clip stop member comprises an inward-extending protrusion on an outer arm of the clip, and wherein the first and second track stop members comprise complementary recesses spaced along an outer lateral track of an occlusal tie wing.

14. The self-ligating orthodontic bracket assembly of claim 11 wherein the bracket further comprises a track extending mesio-distally on the gingival aspect of the occlusal tie wings adjacent to the archwire slot for receiving at least a portion of the gingival transverse member of the clip in the open position.

15. The self-ligating orthodontic bracket assembly of claim 11 wherein the clip further comprises a hole for receiving a tool to move the clip between the open and closed positions.
